(19) United States
(12) Patent Application Publication
(10) Pub. No.: US 2006/0150094 A1
(43) Pub. Date: Jul. 6, 2006

(54) Web companion

(76) Inventor: Zakir Patrawala, Atlanta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/026,694

(22) Filed: Dec. 31, 2004

(51) Int. Cl. G06F 17/21; G06F 17/30; G06F 17/00

(52) U.S. Cl. 715/520; 715/742; 715/500.1; 707/1; 707/10

(57) ABSTRACT

Embodiments of the present disclosure provide systems and methods for presenting network content, such as web documents. Briefly described, in architecture, one embodiment of the system, among others, includes logic configured to retrieve a network document, where the network document is configured to access a plurality of channels of content from at least one remote database. The system further includes logic configured to display the plurality of channels of content, such that the channels are displayed, in succession, within confines of a compact space on a screen of a communication device. In this way, a user can monitor channels of interest while also browsing other information. Other systems and methods are also provided.

### TECHNICAL FIELD

The present disclosure is generally related to network communications and, more particularly, is related to an approach to displaying network content.

### BACKGROUND

A portal site is one term used to refer to a web site with a wide array of content and service. A major portion of advertising revenue for portal sites comes from different revenue streams such as paid banner ads, tile and sky ads, embedded paid listings in various search results originating from the portal page, and directing traffic to e-commerce sites of partners of the portal site. A challenge in order to increase revenue is to make end users spend additional time on the portal site and thus access and view the available advertising.

For example, although a portal site or portal web page(s) may feature a wide variety of content that compels users to spend a lot of time at the portal site, users still visit other web sites as part of their browsing activities. Thus, once users leave the portal site, a challenge exists to bring the users back to the portal site. Also, it may not be sufficient to bring users back to the portal site, in general. Rather, it may be desirable to bring users back to a specific part of the portal site.

Thus, a heretofore unaddressed need exists in the industry to address the aforementioned deficiencies and inadequacies.

### SUMMARY

Embodiments of the present disclosure provide systems and methods for presenting network content, such as web documents. Briefly described, in architecture, one embodiment of the system, among others, includes logic configured to retrieve a network document, where the network document is configured to access a plurality of channels of content from at least one remote database. The system further includes logic configured to display the plurality of channels of content, such that the channels are displayed, in succession, within confines of a compact space on a screen of a communication device. In this way, a user can monitor channels of interest while also browsing other information.

Embodiments of the present disclosure can also be viewed as providing methods for presenting network content. In this regard, one embodiment of such a method, among others, can be broadly summarized by the following steps: retrieving information indicating a current user's preferences on channels of network content to be received by the user; and displaying the channels of network content that are preferred by the current user in succession within a compact space. In this way, a user can monitor channels of interest while also browsing other information.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an Internet based system upon which one embodiment, among others, of the web companion system of the present disclosure may be implemented.

FIG. 2 is a block diagram that further illustrates a web server of FIG. 1.

FIG. 3 is a block diagram of one embodiment of a web browser system for accessing web pages (including portal web sites) and other documents from a web server of FIG. 2.

FIG. 4 is a diagram representing an instance of a web browser application of FIG. 3 displaying a conventional web page.

FIG. 5 is a diagram depicting a process in which a channel receives data from a database within the context of FIG. 4.

FIG. 6 is a screenshot of a web browser application displaying a sample portal web page within the context of FIG. 4.

FIG. 7 is a screenshot of one approach, among others, for personalizing a portal web site according to one embodiment of the web companion system of FIG. 1.

FIG. 8 is a diagram depicting an approach for displaying one channel of information at a time in a compact space within the system of FIG. 1.

FIG. 9 is a screenshot of one embodiment, among others, of a web companion interface of the system of FIG. 1.

FIG. 10 is screenshot of one embodiment, among others, of a web companion interface positioned within a left pane of a web browser application window within the system of FIG. 1.

FIG. 11 is a screenshot showing one embodiment where a web companion module has been embedded in a user's web page within the system of FIG. 1.

FIG. 12 is screenshot showing one embodiment where a web companion module has been embedded in a media player within the system of FIG. 1.

FIG. 13 is screenshot showing one embodiment where a web companion module has been embedded in a chat window within the system of FIG. 1.

FIG. 14 is a screenshot showing one embodiment where a web companion module has been embedded in a portal page within the system of FIG. 1.

FIG. 15 is a flowchart diagram depicting the functionality of a representative implementation of one embodiment of the web companion system of FIG. 1.

FIG. 16 is a diagram showing sample code that may be used to launch a web companion interface from another web page within the system of FIG. 1.

FIG. 17 is a flowchart diagram depicting a representative implementation of one embodiment of the web companion system of FIG. 1.

FIG. 18 is a flowchart diagram depicting a representative implementation of one embodiment of the web companion system of FIG. 1.

### DETAILED DESCRIPTION

Various embodiments of the present disclosure now will be described more fully with reference to the accompanying drawings. Embodiments of the disclosure may include many different forms and should not be construed as limited to the embodiments set forth herein. These embodiments are intended to convey the scope of the disclosure to those skilled in the art. Furthermore, all “examples” given herein are intended to be non-limiting.

Components of a web companion system of the present disclosure can be implemented in software, firmware, hardware, or a combination thereof. In one embodiment of the disclosure, which is intended to be a non-limiting example, the system is implemented in software that is executed by a computer, for example, but not limited to, a personal computer, workstation, mini computer, mainframe computer, personal digital assistants (PDA), mobile phones, etc.

The software-based system, which comprises an ordered listing of executable instructions for implementing logical functions, can be embodied in any computer-readable medium for use by, or in connection with, an instruction execution system, apparatus, or device such as a computer-based system processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device. The computer-readable medium can be, for example, but not limited to, an electronic magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disk read-only memory (CD ROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

In some embodiments, the web companion system of the present disclosure is implemented with use of the Internet. As such, a brief description and explanation of terms associated with the Internet follow. A browser, or “web” browser, allows for simple graphical user interface (GUI) access to network servers, which support documents formatted as so-called web pages. The World Wide Web (WWW), or “web”, is a collection of servers on a network, such as the Internet, that utilize a Hypertext Transfer Protocol (HTTP), which is an application protocol that provides users access to files (which can be in different formats such as text, graphics, images, sound, video, etc.) using a Standard Generalized Markup Language (SGML). SGML is an information management standard for providing platform-independent and application-independent documents that retain formatting, indexing, and linking information. SGML provides a grammar-like mechanism for users to define the structure of their documents and the tags they will use to denote the structure in individual documents. The page description language known as Hypertext Markup Language (HTML) is an application of SGML. HTML provides basic document formatting of text and images and allows the developer to specify hyperlinks, or “links,” to other servers and files.

Use of an HTML-compliant client, such as a web browser, involves specification of an address via a Uniform Resource Locator (URL). Upon such specification, the client makes a TCP/IP request to the server identified in the URL and receives a “web page” (namely, a document formatted according to HTML) in return.

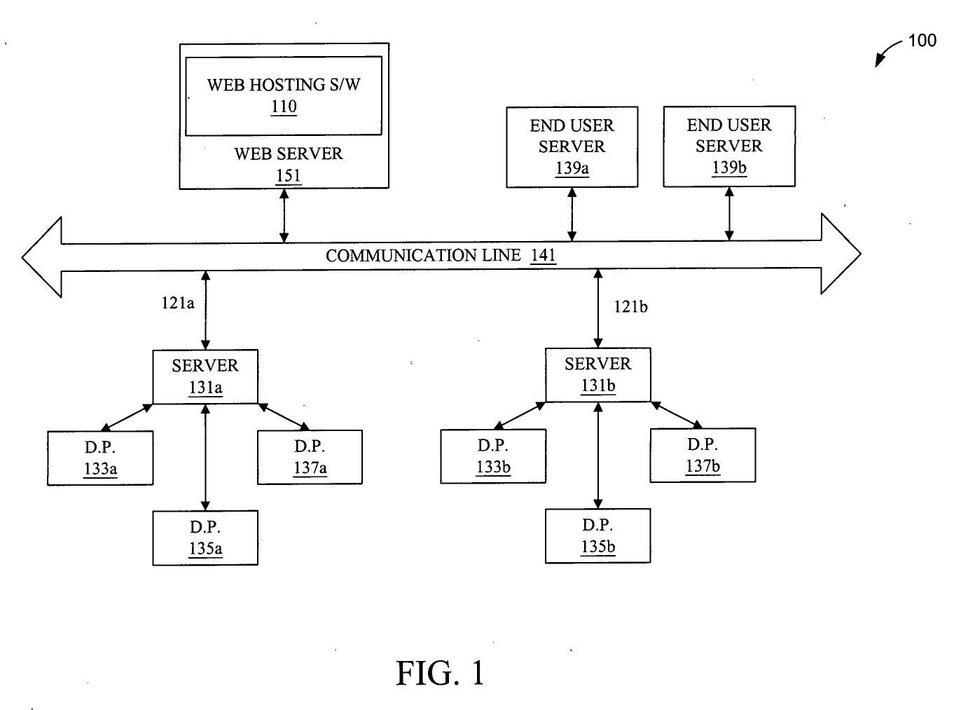

By way of example and illustration, FIG. 1 illustrates a typical Internet based system upon which one embodiment, among others, of the web companion system 100 of the present disclosure may be implemented. It should be noted that while the present disclosure provides implementation of the web companion system 100 within an Internet based system, the web companion system 100 need not be provided via use of the Internet. Instead, one of reasonable skill in the art will appreciate that the web companion system 100 may be implemented within other mediums, such as, for example, but not limited to, a local area network, or wide area network.

Referring to FIG. 1, a plurality of networks 121a, 121b are shown wherein each network 121a, 121a includes multiple digital processors 133a, 135a, 137a and 133b, 135b, and 137b, respectively. Digital processors 133a, 133b, 135a, 135b, 137a, 137b may include, but are not limited to, personal computers, mini computers, laptops, and the like. Each digital processor 133a, 133b, 135a, 135b, 137a. 137b may be coupled to a host processor or server 131a, 131b for communication among processors 133a, 133b, 135a, 135b, 137a, 137b within the specific corresponding network 121a, 121b.

According to an exemplary embodiment, the host processor or server 131a, 131b is coupled to a communication line 141 that interconnects or links the networks 121a, 121b to each other, thereby forming an Internet. As such, each of the networks 121a, 121b. are coupled along the communication line 141 to enable access from a digital processor 133a, 135a, 137a of one network 121a to a digital processor 133b, 135b, 137b of another network 121b. Various end-user servers 139a, 139b, two of which are shown as an example, are linked to the communication line 141, thus providing end-users with access to the Internet. Web hosting software 110 (e.g., HTML web pages) may be maintained on a web server 151 that is connected to the Internet for communication among the various networks 121a, 121b and/or digital processors 133a, 133b, 135a, 135b, 137a, 137b and other end-users connected to the Internet via respective end-user servers 139a, 139b.

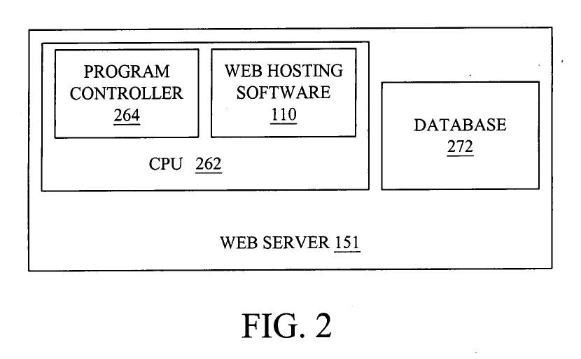

FIG. 2 is a block diagram that further illustrates the web server 151 of FIG. 1.

As shown by FIG. 2, the web server 151 comprises a central processing unit (CPU) 262 having a program controller 264 and web hosting software 110 for implementing a portion of the functionality of the web companion system 100. The program controller 264 is capable of performing functionality required by the web companion system 100, as described in detail hereinbelow. The web server 151 also comprises a web server database 272, which holds data necessary to enable the web server 151 to customize a web site, such as a portal site, in accordance with settings associated with a current user, as described in detail hereinbelow. It should be noted that other information may be stored within the web server database 272 in accordance with one exemplary embodiment of the disclosure.

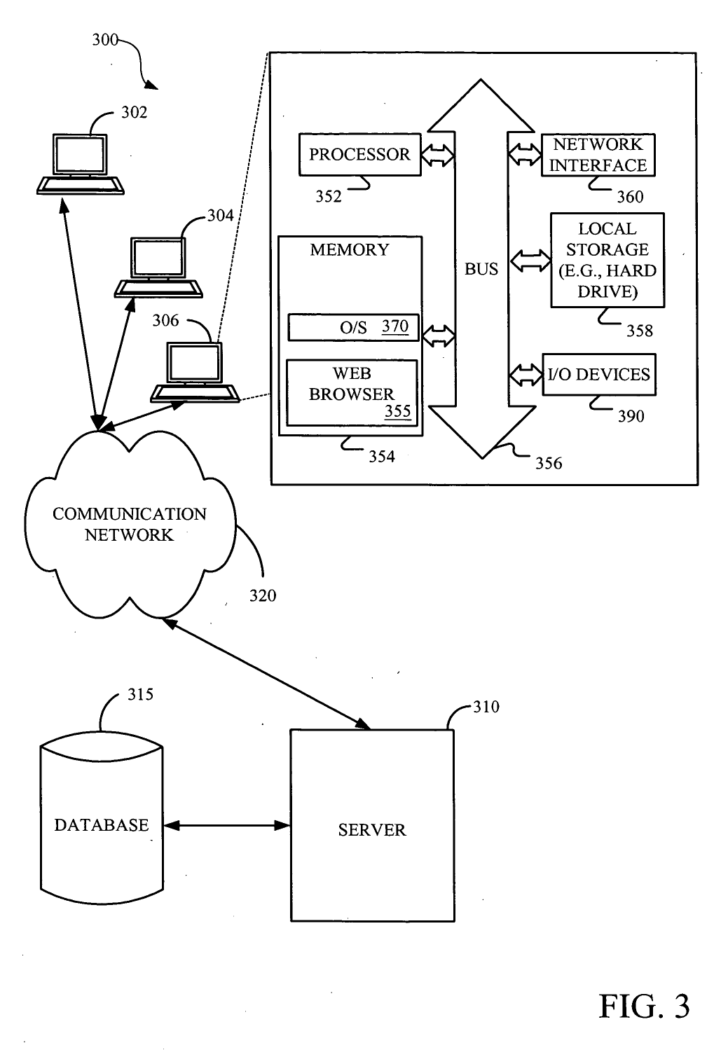

Next, FIG. 3 is a block diagram of one embodiment 300 of a web browser system for accessing web pages (including portal web sites) and other documents from a web server 151. As shown in FIG. 3, the web browser system 300 comprises general-purpose computers 302, 304, 306 that are coupled to a server 310 over a communication network 320 such as the Internet. The communication network 320 provides access to Internet services such as email, file transfer protocols (FTP), World Wide Web (WWW), Internet Relay Chat (IRC), etc. and newsgroups, such as Usenet, among others. The server 310 is coupled to a database 315 that stores user profiles of various users.

In the operating environment shown in FIG. 3, a user of a general-purpose computer 306 (or other computing device like a web-enabled mobile phone, PDA, etc.) attempts to access stored applications on the computer 306 and network services from the network 320. As shown in FIG. 3, the general-purpose computer 306 includes a processor 352, a network interface 360, memory 354, a local storage device 358, and a bus 356 that permits communication between the various components.

While not explicitly shown, it should be appreciated that the other computers 302, 304 may also include similar components that facilitate computation or execution of applications on the computers 302, 304. In some embodiments, among others, the local storage device 358 is a hard drive configured to electronically store data. The local storage device 358 may also store computer programs that execute on the computer 306. In this sense, the processor 352 is configured to access any program that is stored on the local storage device 358, and execute the program with the assistance of the memory 354.

The network interface 360 is configured to provide an interface between the general-purpose computer 306 and the network 320. Thus, the network interface 360 provides the interface for the computer 306 to receive any data that may be entering from the network 320 and, also, to transmit any data from the computer 306 to the network 320. Specifically, in some embodiments, the network interface 360 is configured to permit communication between each of the computers 302, 304, 306 and the server 310 and, additionally, to permit communication between the computers 302, 304, 306 themselves. In this regard, the network interface 360 may be a modem, a network card, or any other interface that communicatively couples each of the computers 302, 304, 306 to the network. Since various network interfaces are known in the art, further discussion of these components is omitted here.

In the embodiment of FIG. 3, a web browser application 355 is shown as being loaded into memory 354 for launching at the general-purpose computer 306, thereby permitting a user of the general-purpose computer 306 to access a web page. The web browser application 355 of one embodiment can be implemented in software, firmware, hardware, or a combination thereof. In some embodiments, the web browser application 355 is implemented in software, as an executable program, and is executed by a special or general-purpose digital computer 306, such as a personal computer, workstation, minicomputer, or mainframe computer. In various embodiments, the web browser application 355, as software, is downloaded from the Internet by the general-purpose computer 306 and subsequently installed on the general-purpose computer 306. In some other embodiments, the web browser application 355, is provided via computer disks, computer cards, or other file-storage devices, or is pre-installed on the general-purpose computer 306.

The memory 354 can include any one or combination of volatile memory elements (e.g., random access memory (RAM, such as DRAM, SRAM, etc.)) and nonvolatile memory elements (e.g., ROM, hard drive, tape, CDROM, etc.).

Moreover, the memory 354 may incorporate electronic, magnetic, optical, and/or other types of storage media. Note that the memory 354 can have a distributed architecture, where various components are situated remote from one another, but can be accessed by the processor 352.

The software in memory 354 may include one or more separate programs, each of which comprises an ordered listing of executable instructions for implementing logical functions. In the example of FIG. 3, the software in the memory 354 includes the web browser application 355, and an operating system (O/S) 370. The operating system 370 essentially controls the execution of other computer programs, and provides scheduling, input-output control, file and data management, memory management, and communication control and related services.

The web browser application 355 may be a source program, executable program (object code), script, or any other entity comprising a set of instructions to be performed. The I/O devices 390 may include input devices, for example but not limited to, a keyboard, mouse, scanner, digital camera, multi-function device, digital sender, microphone, etc. Furthermore, the I/O devices 390 may also include output devices, for example but not limited to, a printer, display, etc. Finally, the I/O devices 390 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

The software in the memory 354 may further include a basic input output system (BIOS) (omitted for simplicity). The BIOS is a set of software routines that initialize and test hardware at startup, start the O/S 370, and support the transfer of data among the hardware devices. The BIOS is stored in ROM so that the BIOS can be executed when the computer 306 is activated. When the computer 306 is in operation, the processor 352 is configured to execute software stored within the memory 354, to communicate data to and from the memory 354, and to generally control operations of the computer 306 pursuant to the software. The web browser application 355, and the O/S 370, in whole or in part, are read by the processor 352, perhaps buffered within the processor 352, and then executed.

When the web browser application 355 is implemented in software, as is shown in FIG. 3, it should be noted that the web browser application 355 can be stored on any computer readable medium for use by or in connection with any computer related system or method. The web browser application 355 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In an alternative embodiment, where the web browser application 355 is implemented in hardware, the web browser application 355 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

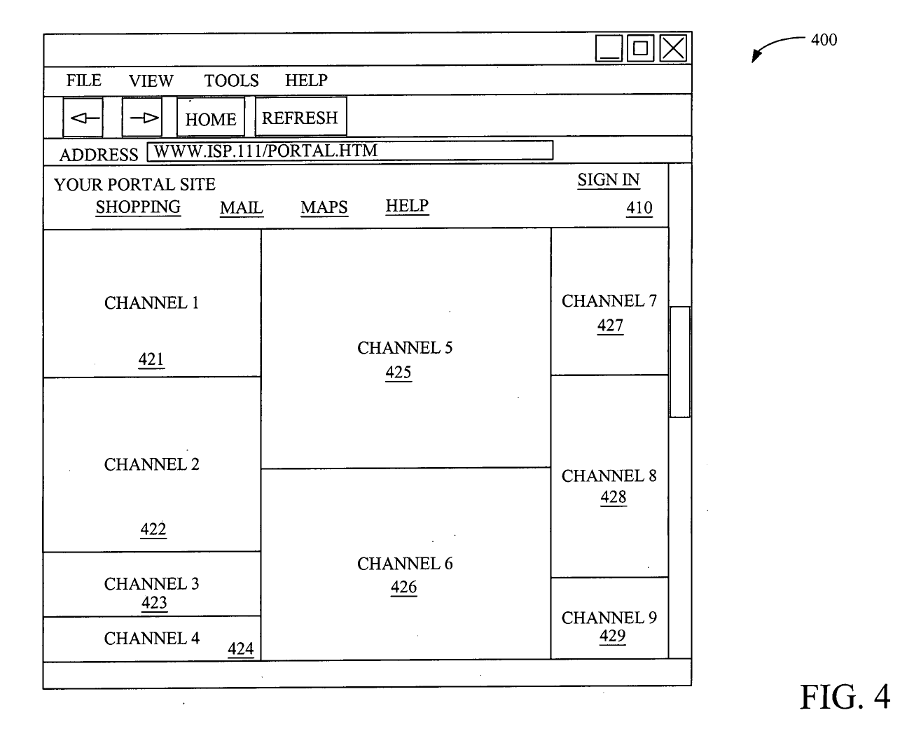

Now referring to FIG. 4, many web pages, such as portal web pages, provide a wide variety of content that is easily accessible to a current user. For example, a portal web page may be distinctly divided into different sections, such as a banner ad section, one or more navigation bars, two or three columns of personalized content, etc. For reference, FIG. 4 shows a representation 400 of an instance of a web browser application 355 displaying a conventional sample portal web page 410. In this representation, the web page 410 is composed of different informational boxes or channels 421-429 that are each displayed within the confines of the web page 410.

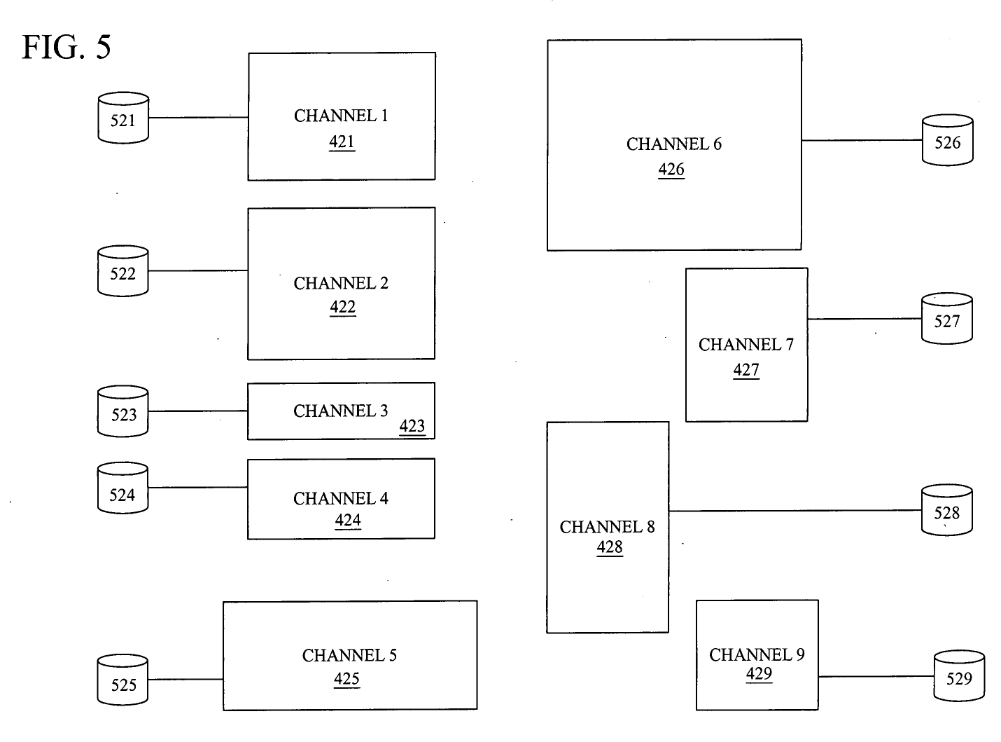

Data for each channel 421-429 may be received from a separate network database 521-529, as depicted in FIG. 5. Note, although the data for each channel 421-429 may come from different databases 521-529, the databases 421-429 are hosted within the same portal network or infrastructure, in some embodiments.

Via a respective channel, an open connection is maintained between a web browser 355 and a network database 315 and portions of data, which is usually JavaScript or HTML code, is transmitted to and executed by the web browser 355.

The execution of code modifies segments of the web page that is currently being displayed. In some embodiments, the channels are refreshed as part of the portal web page when the page is loaded. In others, the channels may be refreshed individually, rather than updating the web page as a whole.

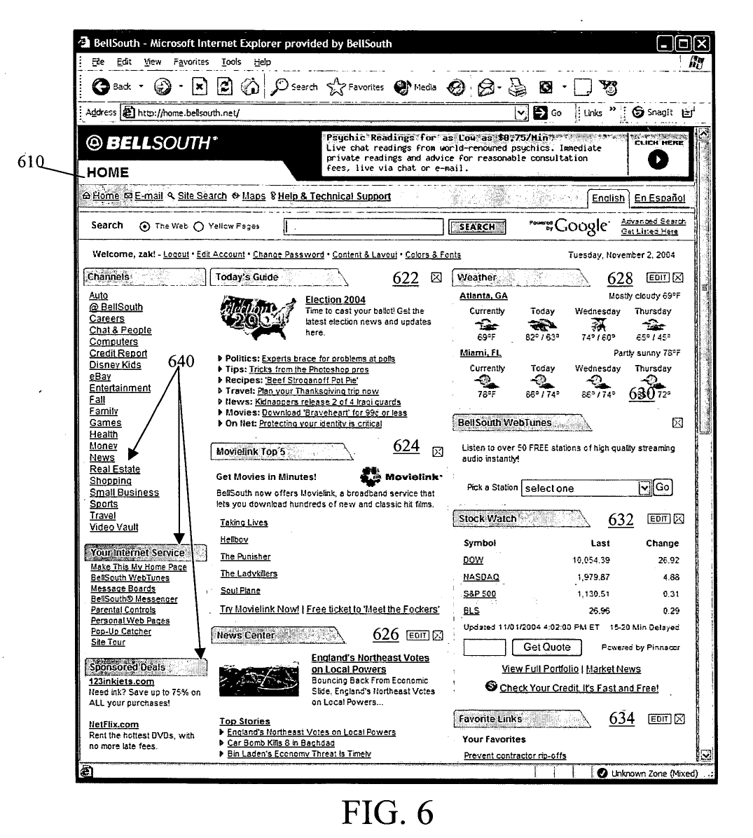

For example, channel 1 may show one type of data, such as sports information, and this data is received from database 521. Accordingly, channel 2 may shown a different type of data, such as weather information and this data is received from database 522. Correspondingly, each of the other channels 423-429 may also receive data from other databases 523-529. For further illustration, FIG. 6 is a screenshot of a web browser application displaying a sample portal web page 610 with a variety of channels 622-634, as previously discussed with regard to FIG. 5.

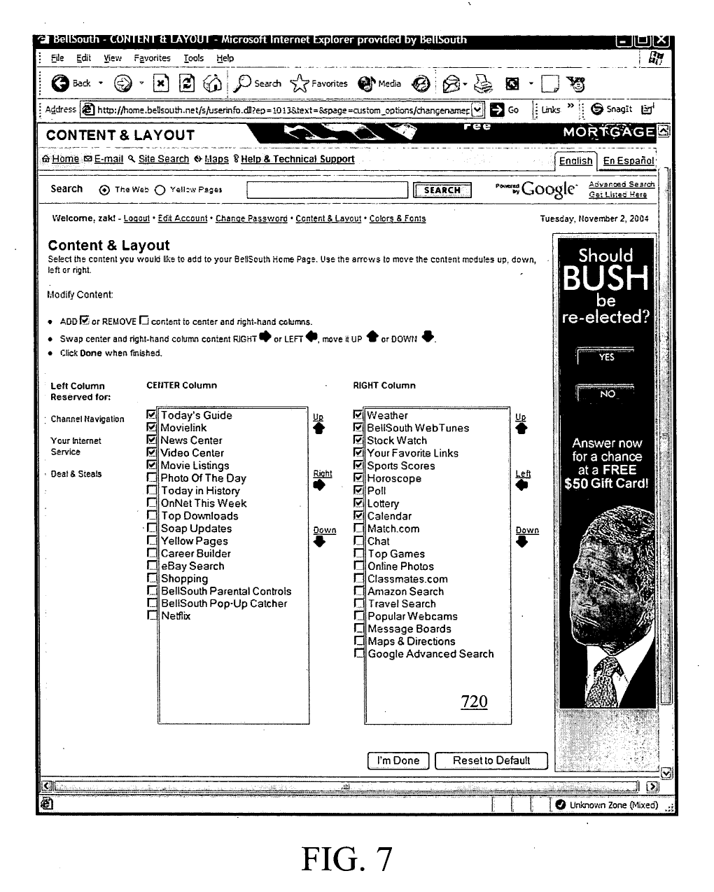

A current user can choose or personalize the type of content that is displayed by a channel within a portal web site. For example, the screenshot in FIG. 7 shows one approach, among others, for personalizing a portal web site. As shown in FIG. 7, a user can indicate his or her preferred categories of content from a web page interface 710 by selecting checkboxes associated with each category. In addition, the use can arrange how the content is displayed by choosing, for example, to have the category located in a center column of the portal web page, or a right column of the portal web page, and by relative positioning the categories. For example, within the input box 720 for choosing content for the right column, the “Weather” option is positioned above the “BellSouth WebTunes” option, which is above the “Stock Watch” option.

Accordingly, on the corresponding portal web page 610 in FIG. 6, the Weather channel 628 is positioned above the Web Tunes channel 630, which is positioned above the Stock Watch channel 632 on the right column of the page 610.

As can be seen by the portal web page 610 of FIG. 6, even after personalizing the web page, a user could perceive the web page 610 as appearing busy or cluttered with all of the personalized content 622-630 being shown along with extraneous information 640. Further, in this example, a large portion of the content (e.g., Weather, Favorite Links, etc.) of the page 610 is either static or is updated once a day.

Because of a high page weight, the contents of the web page 610 cannot be set to refresh at a fixed interval, which places a significant load on web servers 151. As such, launching, loading, and displaying a portal web page with a lot of content may take a few seconds on slow network connections or on computers with small amounts of memory. Moreover, once loaded, the portal web page 610 occupies a considerable portion of the screen (of a computing device), because of its designed layout.

As such, the portal web page 610 in FIG. 6 also cannot be embedded inside another web page, such as a user's personal web page, or a web browser's pane/explorer bar (e.g., the left area of a browser display where favorites, history, search, etc. can be displayed). Additionally, the portal web page 610 of FIG. 6 cannot be placed inside a media player device, or chat application window.

Therefore, users often switch between viewing content on the portal web page (that takes occupies most of a screen of a computing device) and the content of another web page or application (that also occupies much of the screen of the computing device). Alternatively, users may choose to exit and close the instance of the web browser 355 containing the portal web page in order to continue a web browsing session from another instance of a web browser application 355.

Various embodiments of the present disclosure account and resolve some or all of the aforementioned issues by employing a web companion interface for displaying a lighter and smaller version of a content-rich web page, such as a portal web page. In some embodiments, the web companion interface is launched as an instance of a web browser that is a lighter and smaller version of a standard instance of the web browser application 355. In other embodiments, the web companion interface is a compact module positioned within a larger web page. The web companion interface, in some embodiments, displays information in an area the size of one column width, for example. However, the height of the web companion interface may be changed and set by users, in some embodiments.

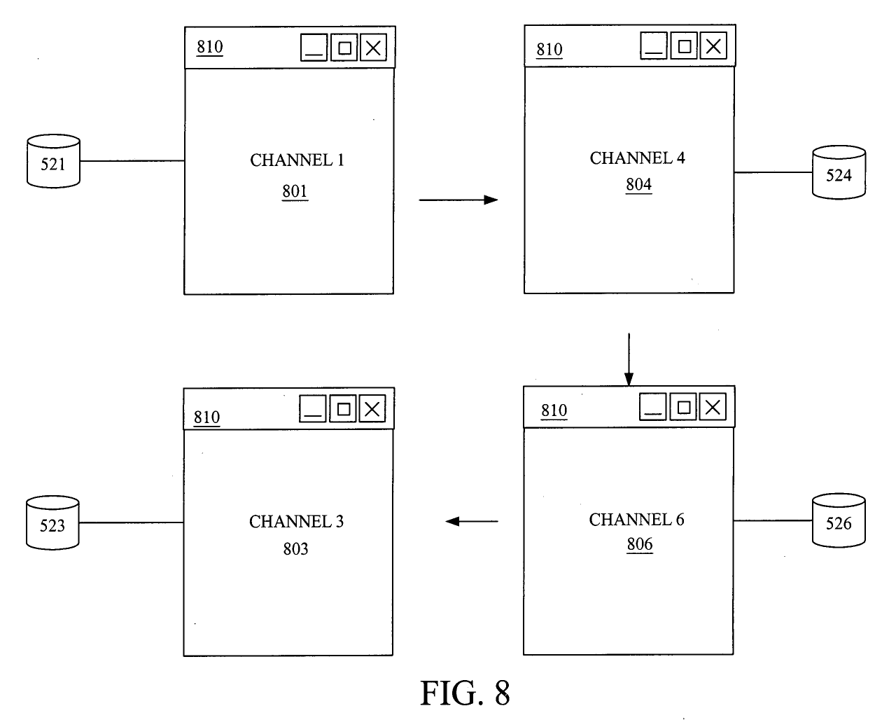

According to exemplary embodiments, the web companion interface displays personalized content that is pre-selected by a user and is also displayed on a portal web site (as shown in FIG. 1). However, unlike a portal web site, the web companion interface displays one channel of information at a time in a compact space, as represented in FIG. 8. In this representation, channel 1 information 801 from database 521 is shown in the web companion interface 810. After some period of time, channel 1 information (e.g., sports information) is then followed with information 804 from channel 4 (from database 524) (e.g., entertainment news) that is displayed on the web companion interface 810. Subsequently, information 806 from channel 6 (of database 526) and information 803 from channel 3 (of database 523) are also displayed in the web companion interface 810.

Therefore, channel information is shown one at a time. To do so, some embodiments enable the web companion interface 810 to present information in a “scrolling content” mode and/or a “slide show” mode. In the scrolling content mode, for example, content is scrolled at a fixed speed as selected by user (very slow, slow, medium, fast, etc). In the slide show mode, the web companion interface 810 shifts from one information box to the next box after pausing for a fixed interval as set by user (very slow, slow, medium, fast, etc). Further, in some embodiments, scrolling or slide show modes pause as long as a cursor from an input control device (such as a mouse control or keyboard control) is moved over a web companion interface window. To configure these modes, in some embodiments, a user may specify a preferred mode in a user profile that is accessed by a web server 151 and used by the web server 151 to present information within the web companion interface 810 in a manner preferred by the current user.

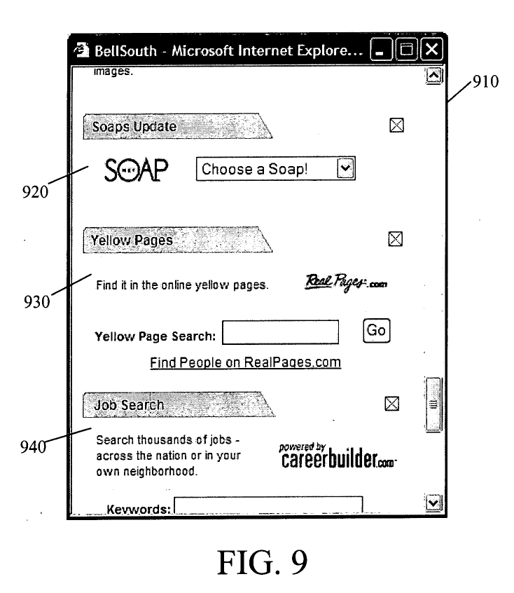

After scrolling or slide-showing each channel associated with the selected informational categories, the contents of the web companion interface 810 are refreshed from a web server 151. The refresh time, however, may be configured differently by a user. For example, user may be given an option to choose (in configuring a user profile) to refresh after all channels have been displayed or after a set amount of time (e.g., 10 minutes). To illustrate, FIG. 9 shows a screenshot of one embodiment 910, among others, of the web companion interface 910 in scrolling content mode. As shown, the web companion interface 910 displays information from a channel 920 associated with “Soap Videos” which has scrolled to the top of the interface 910. Following the “Soap Videos” channel 920, a channel 930 associated with “Find a Movie” is displayed and is followed by a channel 940 associated with “Photo of the Day.”

Since the web companion interface 910 loads less content information than a typical portal web page, the web companion system 100 puts a lesser load on the web server 151, and the web companion interface 810 loads much quicker than a typical portal page. For some embodiments where the web companion interface 810 is displayed in a compact web browser, the web companion interface does not have the address bar of a typical web browser and other menu and toolbar interfaces. However, a vertical scroll bar on the web companion interface 810 may be displayed if space permits. Keyboard navigation keys may also be provided (e.g., Home, End, Arrow Keys, Page Up, Page Down, Refresh, Alt F4, etc.), in some embodiments.

For some embodiments, by clicking on a web link being displayed by the web companion interface, a new instance of a web browser 355 is opened to display the web page associated with the link. The newly opened web browser instance contains the typical address bars, menu, and toolbar interfaces of a standard web browser window, in some embodiments. An additional click of a web link of the web companion interface causes the recently opened web browser instance to display a new web page, in some embodiments, or to open a new instance of the web browser 355 for displaying the web page associated with the web link.

Alternatively, since the width (of the web companion interface) is one column size, for some embodiments, the web companion interface is narrow enough to fit in a regular web browser's left pane, also called an explorer bar. Therefore, clicking on a link or executing an operation of the web companion interface in the left pane (e.g., a request to perform a search operation) causes a web page to open in the main window to the right of the web companion interface (e.g., a web page showing search results).

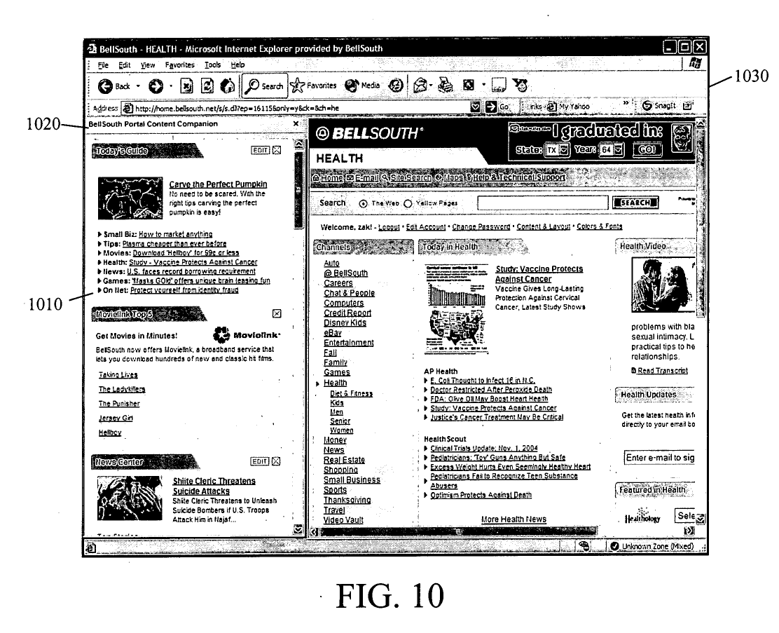

In this way, a user is able to continually access the web companion interface while viewing other web pages, for example. To illustrate, the screenshot of FIG. 10 displays one embodiment having a web companion interface 1010 positioned within a left pane 1020 of a web browser application window 1030.

Further, in some embodiments, a user can configure his or her own personal web page to include the web companion interface (e.g., by inserting a sample tag in a user's personal page, such as <iframe src=“http://home.bellsouth.111/webcompanion” width=350 height=400/>). This is another way that a web companion interface can provide a wide variety of informational content while not monopolizing the real estate of a desk top or screen of a computing device.

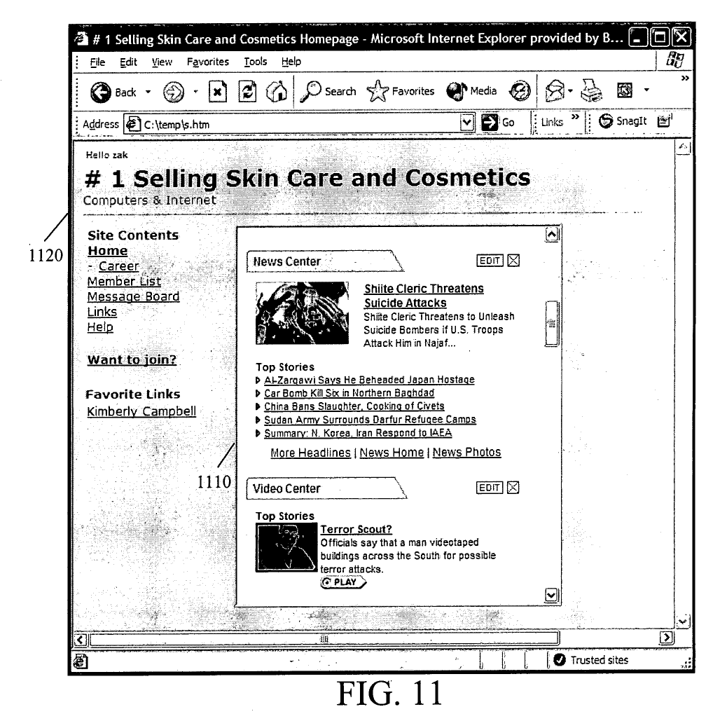

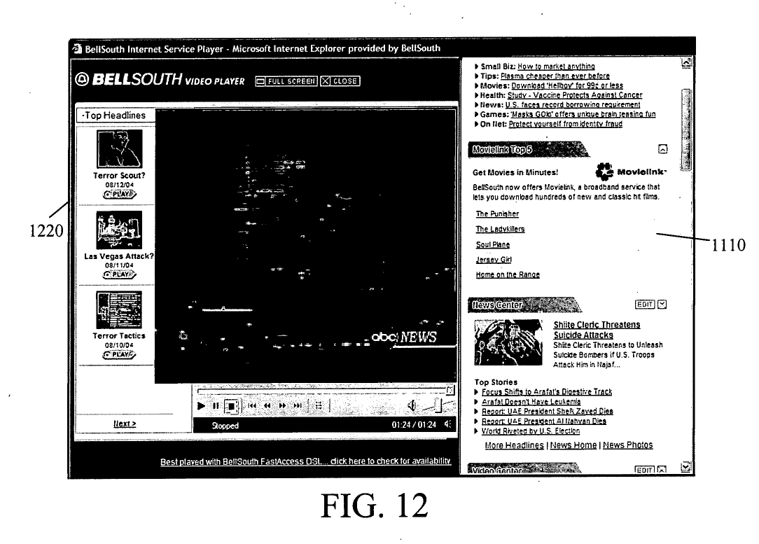

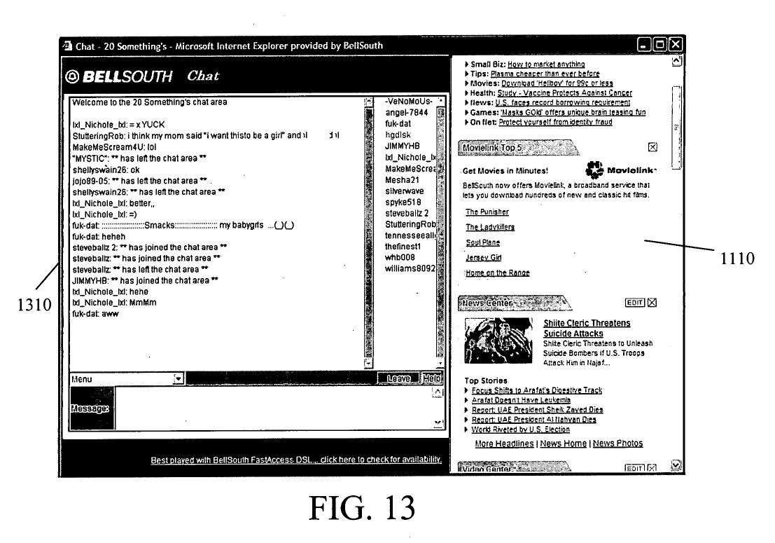

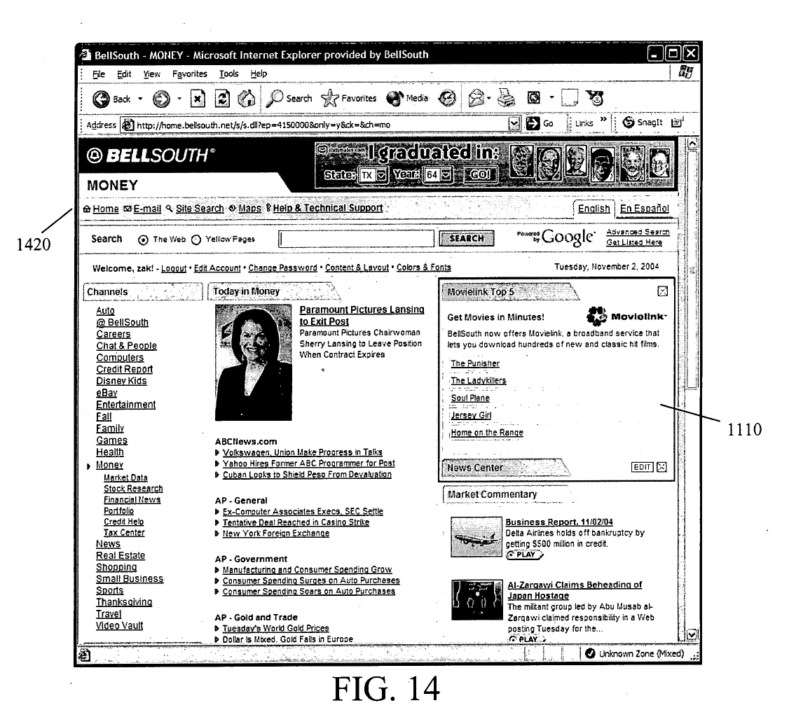

In addition, the web companion interface may be included in Internet documents, such as a media player/viewer or a chat window. The web companion interface can also be embedded in important portal web pages where users spend more time and/or result in high revenues, such as channel's main pages (e.g., merchant web sites, web search applications, special topic areas, etc). Correspondingly, FIGS. 11-14 are screenshots showing various embodiments where a web companion module 1110 has been embedded in a user's web page 1120, a media player 1220, a chat window 1320, and a portal web page 1420, respectively.

As previously mentioned, computing devices other than a general-purpose computer may also employ web browser applications that can take advantage of the benefits of the web companion interface. Moreover, the web companion interface may be particularly beneficial for computing devices with small display screens. As one example, among others, a cell phone enabled with a web browser can use the web companion interface as a homepage for the cell phone device to view the same personalized content that is available on a cell phone user's portal site.

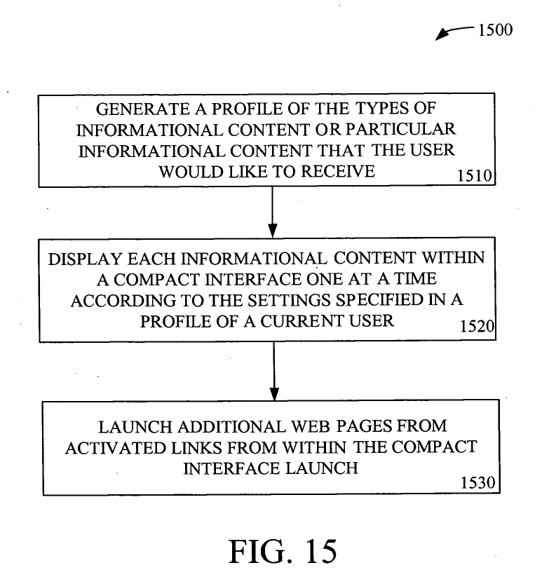

Next, the flowchart of FIG. 15 shows the functionality of a representative implementation 1500 of one embodiment of the web companion system 100. With regard to all flow charts described herein, each block represents a module, segment, or portion of code, which comprises one or more executable instructions for implementing the specified logical function(s). It should also be noted that in some alternate implementations, the functions noted in the blocks may occur out of the order noted. For example, two blocks shown in succession may in fact be executed substantially concurrently, or the blocks may sometimes be executed in the reverse order, depending upon the functionality involved.

In this particular process 1500, a user generates (1510) a profile indicating the types of informational content or particular informational content that the user would like to receive on a computing device. As part of this process, the user may rank or prioritize which informational content is preferred over other informational content.

Then, each informational content is displayed one at a time (1520) within a compact interface (e.g., having a one column wide window width) according to the settings specified in a profile of a current user. Note, these settings may also be used to display content within a portal site along with extraneous information. For either situation, a user may identify himself or herself by logging into the web server and then a web server delivers personalized content as specified in the user's profile.

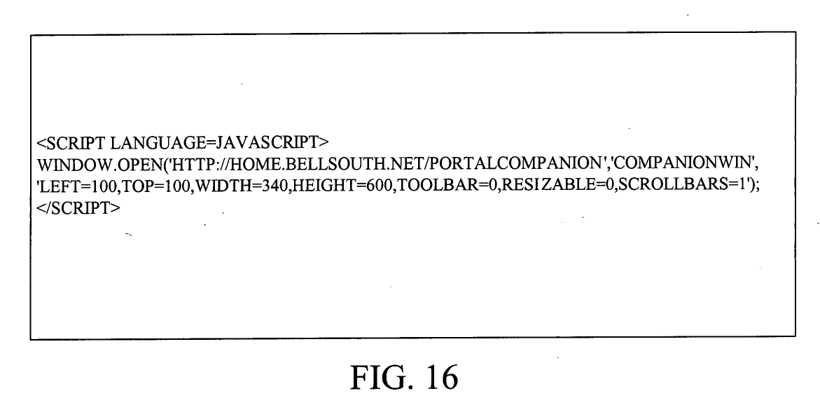

Activated links, from within the compact interface, launch (1530) additional web page(s) for viewing by the user. However, unlike other devices, such as a web browser toolbar, a user does not need to download additional software to execute the web companion interface in concert with a web browser application 355. For example, implementations of some exemplary embodiments of the web companion interface are completely web based and do not involve extra setup. For instance, a link on a portal page may be provided so that users can click the link and automatically launch the web companion interface. FIG. 16 shows a sample code that could be used to launch a web companion interface from another web page. Therefore, common user-concerns about downloading software and causing side effects and privacy threats are avoided. Further, the web companion interface can be opened when needed, whereas a web browser toolbar occupies a portion of the browser all the time. Note, with the limited and compact size of the web companion interface, a user of a general-purpose computer can view both the contents of the web companion interface and the contents of a web page being displayed. Therefore, for users who continually monitor real time content such as stock price, news headlines, current weather etc., a user can view the entirety of such content in the web companion interface while also viewing another web page in another window of a web browser.

In this way, a user is encouraged to leave the web companion interface open on a computer desktop (or a screen of another computing device) while the user is browsing other web pages or using other computer applications. Thus, the web companion interface receives content from different data streams over an extended amount of time. In some embodiments, this content includes links to other web pages that contain advertising banners, merchant links, and/or other advertising content. Since the web companion interface is likely to be used quite often and for extended periods by users, the web companion interface generates more page views of these external web pages and publishes more advertisements from these external web pages than a standard portal web site. As a result, additional advertising revenue is generated for a provider of the web companion interface by directing traffic to paid partners.

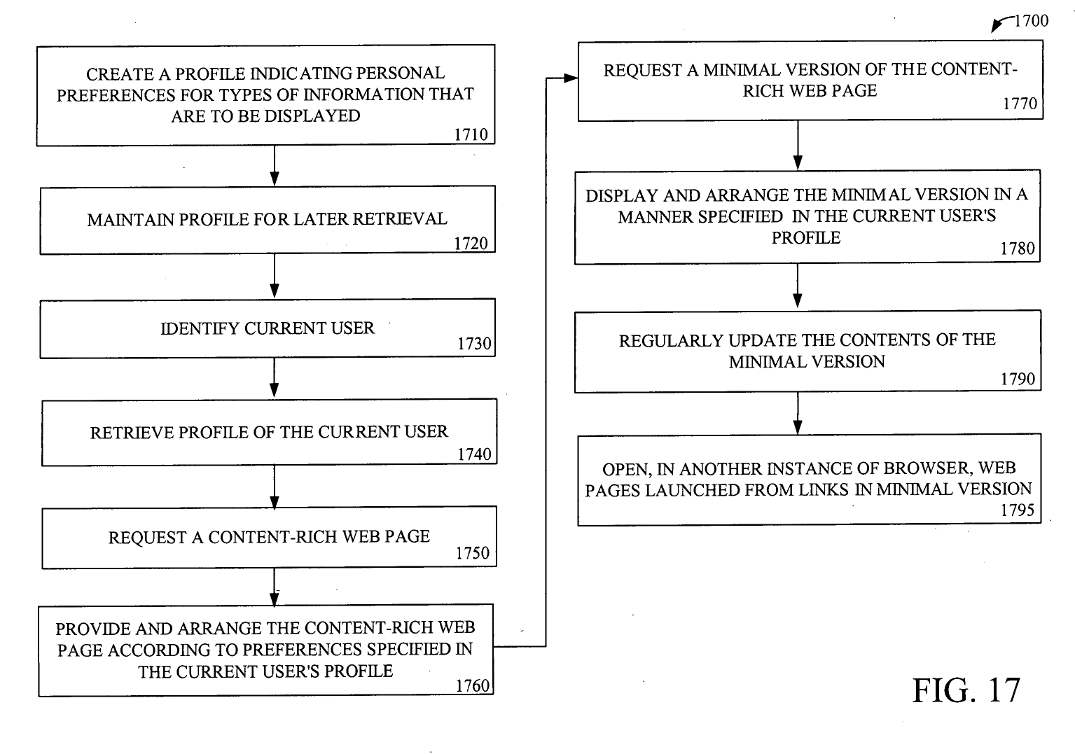

Now referring to FIG. 17, a representative implementation 1700 of one embodiment of the web companion system 100 is shown. First, a user creates (1710) a profile indicating personal preferences for types of information that are to be displayed to the user during a web browsing session. In some embodiments, the profile may also contain additional information such as preferences regarding how selected information should be displayed (e.g., in what order, in which location, for how long, etc.). The profile is maintained (1720) by a web server and database for later retrieval. Accordingly, during a web browsing session, a current user can identify (1730) himself or herself to the web server (e.g., by logging in from a web page, such as a portal web page) and retrieve (1740) the profile of the current user. Thus, a content-rich web page (such as a portal page) stored on the web server can be requested (1750) by the current user and provided (1760) with personalized information and be arranged according to preferences specified in the current user's profile. The personalized information includes informational boxes or channels previously selected by the user (e.g., informational box directed to the weather, horoscope channel, sports channel, informational box directed to job postings, etc.). In addition, the portal page may contain extraneous information selected by the provider of the content-rich web page, such as advertising and other items that the provider would like users to view or believes might be of interest to users, in general.

In addition, a user can request (1770) a minimal version of the content-rich web page (e.g., by clicking a link or uniform resource locator (URL) from another web page). The minimal version is displayed (1780) in a small scaled-back instance of a web browser application window (e.g., by specifying the size of the window in the URL of the minimal version, along with other configurable options such as options for not displaying an address bar, navigational bars, toolbars, menus, etc.). Within the small instance of the browser window, the minimal version of the content-rich web page (“minimal web page”) displays only the personalized or customized information that is described in the current user's profile and presented in a manner also indicated in the current user's profile (e.g., scrolling presentation, slideshow presentation, order in which information is presented, speed of presentation, etc.) Each particular piece of personalized information is shown one after the other in a particular sequential fashion. In some embodiments, a user may define the order in which pieces of information are shown such that one piece of information may be shown more frequently relative to another piece of information within a round or cycle of displaying all of the pieces of information described in the profile. The contents of the information pieces are updated (1790) in a regular fashion (e.g., after every round, after 10 minutes, etc.). The manner in which pieces of information are update can be specified in the profile of the user, in some embodiments. Within the information or content shown in the minimal web page, links to other web documents (e.g., applications, web pages, media files, etc.) are included. When a user selects (1795) a link from the minimal web page, the web document associated with the link is opened in a new instance of the web browser according to instructions contained in the link.

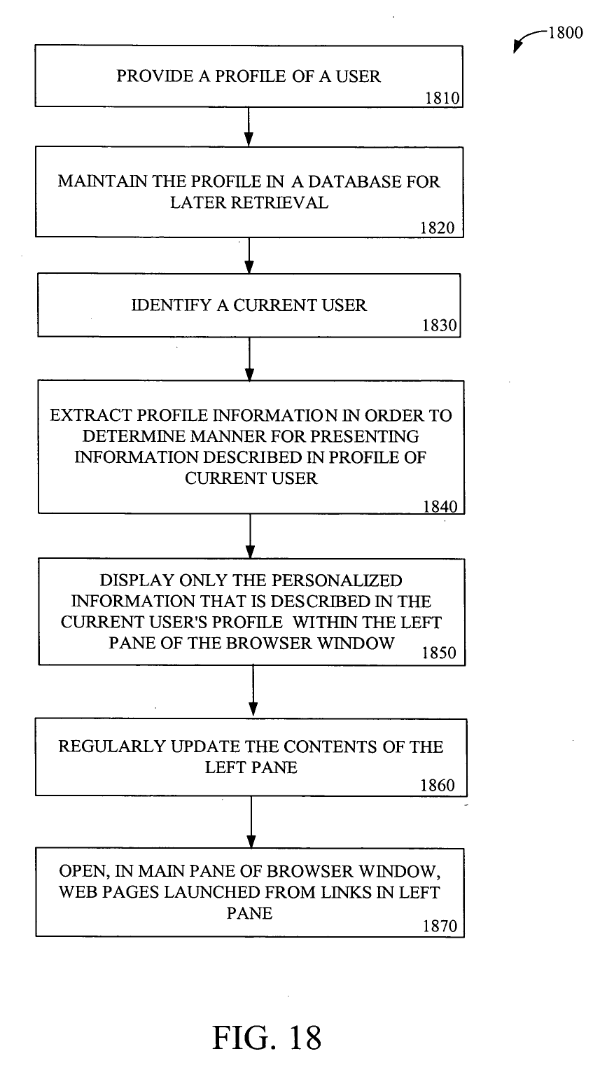

Next, FIG. 18 shows a flowchart describing a representative implementation 1800 of another embodiment of the web companion system, among others. First, a profile of a user is provided (1810). The profile includes listed personal preferences for types of information that are to be displayed to the user during a web browsing session. The profile is maintained (1820) by a web server and database for later retrieval. Accordingly, during a web browsing session, a current user can identify (1830) himself or herself to the web server (e.g., by logging in from a web page, such as a portal web page). Profile information is then extracted by the server in order to determine (1840) a manner for presenting, in sequential order, information channels of types specified in the current user's profile within, e.g., a left pane of a web browser window (that may be, for example, one column wide).

Within the left pane of the browser window, only the personalized or customized information that is described in the current user's profile being shown and presented in a manner indicated in the current user's profile (e.g., scrolling presentation, slideshow presentation, order in which information is presented, speed of presentation, etc.) is displayed. The contents of the information pieces are updated (1860) in a regular fashion (e.g., after every round, after 20 minutes, etc.). Within the information or content shown in the left pane, links to other web documents (e.g., applications, web pages, media files, etc.) are included. When a user selects (1870) a link from the left pane, the web document associated with the link is opened in the main pane of the web browser window. To implement the left pane within a web browser application, such as Microsoft Internet Explorer®, objects of the web browser application can be modified to display a left pane having the web companion interface. Further, registry information for the web browser application can be configured to include an option for activating the web companion interface from a menu interface on the web browser application, for example.

It should be emphasized that the above-described embodiments of the present disclosure are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

Therefore, having thus described the invention, at least the following is claimed:

1. A system for presenting network content, comprising:
logic configured to retrieve a network document, the network document configured to access a plurality of channels of content from at least one remote database; and
logic configured to display the plurality of channels of content in succession within confines of a compact space on a screen of a communication device.

2. The system of claim 1, wherein the plurality of channels are preselected by the user of the communication device.

3. The system of claim 2, further comprising:
logic configured to select a channel of content for later viewing by a user.

4. The system of claim 1, wherein the channels of content are displayed in an instance of a web browser that is limited to showing content within a one column space.

5. The system of claim 4, wherein the channels of content are displayed in succession by scrolling the channels of content within the one column space in sequential order.

6. The system of claim 4, wherein the channels of content are displayed in succession by showing a channel of content for a set period of time and then replacing a current channel of content with a new channel of content.

7. A method for presenting network content, comprising the steps of:
retrieving information indicating a current user's preferences on channels of network content to be received by the user; and
displaying the channels of network content that are preferred by the current user in succession within a compact space.

8. The method of claim 7, wherein the information indicating the preferences is obtained from a profile for formatting a portal web page displaying multiple channels of network content across multiple columns.

9. The method of claim 7, wherein the channels of network content are displayed in an instance of a web browser that is limited to showing network content that fits in a one column space, the method further comprising the step of:
opening a web page that is initiated by activation of a link from one of the channels of network content in a different instance of the web browser.

10. The method of claim 7, wherein the channels of network content are displayed in succession by scrolling the channels of network content within the one column space in sequential order.

11. The method of claim 10, further comprising the step of:
specifying a speed for scrolling the channels of network content.

12. The method of claim 7, wherein the channels of network content are displayed in succession by showing a channel of network content for a set period of time and then replacing a current channel of network content with a new channel of network content.

13. The method of claim 12, further comprising the step of:
specifying the period of time for showing the channel of network content.

14. The method of claim 7, wherein the channels of network content are displayed in a left pane of an instance of a web browser that is limited to showing network content that fits in a one column space, the instance of the web browser having the left pane and a main pane for displaying network content, the method further comprising the step of:
opening a web page in the main pane of the instance of the web browser, wherein the opening of the web page is initiated by activation of a link from one of the channels of network content being shown in the left pane.

15. A computer readable medium having a computer program for presenting network content, the program for performing the steps of:
retrieving information indicating a current user's preferences on channels of network content to be received by the user; and
displaying the channels of network content that are preferred by the current user in succession within a compact space.

16. The medium of claim 15, wherein the information indicating the preferences is obtained from a profile for formatting a portal web page displaying multiple channels of network content across multiple columns.

17. The medium of claim 15, wherein the channels of network content are displayed in an instance of a web browser that is limited to showing network content that fits in a one column space, the method further comprising the step of:
opening a web page that is initiated by activation of a link from one of the channels of network content in a different instance of the web browser.

18. The medium of claim 15, wherein the channels of network content are displayed in succession by scrolling the channels of network content within the one column space in sequential order.

19. The medium of claim 15, wherein the channels of network content are displayed in succession by showing a channel of network content for a set period of time and then replacing a current channel of network content with a new channel of network content.

20. The medium of claim 15, wherein the channels of network content are displayed in a left pane of an instance of a web browser that is limited to showing network content that fits in a one column space, the instance of the web browser having the left pane and a main pane for displaying network content, the method further comprising the step of:
opening a web page in the main pane of the instance of the web browser, wherein the opening of the web page is initiated by activation of a link from one of the channels of network content being shown in the left pane.
